(19) United States
(12) Patent Application Publication
(10) Pub. No.: US 2007/0012860 A1
(43) Pub. Date: Jan. 18, 2007

(54) Optical source with ultra-low relative intensity noise (RIN)

(76) Inventors: Daniel Mahgerefteh, Los Angeles, CA (US); Yasuhiro Matsui, Lawrence, MA (US); Parviz Tayebati, Weston, MA (US)

Correspondence Address: Mark J. Pandiscio;Pandiscio & Pandiscio, P.C., 470 Totten Pond Road, Waltham, MA, 02451-1914, US

(21) Appl. No.: 11/418,707

(22) Filed: May 5, 2006

Related U.S. Application Data
(60) Provisional application No. 60/678,014, filed on May 5, 2005.

(51) Int. Cl. G01J 1/32; H01J 40/14

(52) U.S. Cl. 250/205; 250/214 R

(57) ABSTRACT

Apparatus for the generation of ultra-low noise light comprising: a laser generating light at a central frequency and having a frequency dependent relative intensity noise spectrum; and an optical filter having a substantially conjugate symmetric transfer function; wherein the center frequency of the light generated by the laser is substantially aligned with the peak transmission frequency of the filter; and wherein the transmission function of the filter is chosen, and the frequency dependent relative intensity noise spectrum of the laser is adjusted, to reduce the resulting relative intensity noise of the light at the output of the filter over a range of frequencies by causing the relative intensity noise spectrum of the laser to occur at frequencies for which the filter has substantial loss.

### REFERENCE TO PENDING PRIOR PATENT APPLICATIONS

This patent application claims benefit of pending prior U.S. Provisional Patent Application Ser. No. 60/678,014, filed May 05, 2005 by Daniel Mahgerefteh et al. for ULTRA LOW RELATIVE INTENSITY NOISE LASER MODULE (Attorney Docket No. TAYE-55 PROV).

The above-identified patent application is hereby incorporated herein by reference.

### FIELD OF THE INVENTION

This invention relates to laser sources in general, and more particularly to low noise laser sources for high dynamic range analog communication systems.

### BACKGROUND OF THE INVENTION

Analog fiber optic communication requires lasers with low relative intensity noise (RIN) and high power to increase their linear dynamic range. Analog fiber links typically comprise a high-power, continuous-wave (CW) laser diode and an externally modulated Lithium Niobate (LiNbO₃) modulator, which is used to modulate the optical carrier with a radio frequency (RF) signal such as a video signal. This signal is launched into an optical fiber and is detected at the other end of the fiber by a high speed photodiode. The resulting RF signal in the detector ideally reproduces the RF signal input at the transmitter end. The LiNbO₃ modulator is biased near its linear point of transfer function for maximum linearity. This minimizes even-ordered harmonic distortions. Therefore, the communication link's distortion is typically limited by third-order nonlinearity dictated by the approximately sinusoidal transfer function of the modulator.

A key metric of fidelity for an analog RF link is its spurious free dynamic range (SFDR). The SFDR, shown in FIG. 1, is the input RF power range over which faithful reproduction of an input signal occurs without generation of any spurious harmonic signals. Usually such distortion is most pronounced when two closely spaced fundamental frequency tones, f₁, and f₂, are transmitted over the communication link (FIG. 1). Third order nonlinearities generate new frequencies 2f₁-f₂ and 2f₂-f₁. These nonlinear spurious tones become significant at high input RF powers to the modulator and limit the dynamic range at the high power side. The dynamic range at the low power levels is limited by the noise of the systems. It is desired to increase the dynamic range to allow detection of small signals in the presence of large signals. The SFDR can be increased in two ways: (1) by making more linear modulators, and (2) by reducing the total noise of the system.

It is an object of the present invention to reduce the total noise of such a system by providing a method and apparatus for generation of laser light having ultra-low noise.

Laser noise is a key component of the total noise of an analog fiber optic link, since the power of the light going into the detector is generally kept high to overcome the thermal noise of the detector. Laser RIN is defined as the ratio in decibels of the mean square of the fluctuations in the laser intensity to the square of the average intensity. Solid state lasers exist that have low RIN ˜−170 dB/Hz. However, such solid state lasers are typically large and have high power consumption. Compact semiconductor lasers with relatively high power (approximately 40 mW) are now available, but they typically have a RIN of ˜−150 dB/Hz.

In cable TV applications where the RF carrier is in the MHz or 1 GHz range, the semiconductor RIN is adequately low.

In other applications, the semiconductor RIN is high enough to present significant problems. The present invention is directed towards providing an optical source with a very low RIN so that the optical source can be used in such other applications.

The RIN spectrum of a semiconductor laser peaks near its resonance frequency (typically ˜10 GHz), but is very low in the MHz and 1 GHz range. However, as the bandwidth (BW) requirements for analog communication increases, higher frequency RF carriers are needed, requiring compact lasers with low RIN over a wide band of frequencies in the multi-GHz range. Also, in certain military applications in which an RF signal is directly converted from the antenna to an analog optical transmitter, the link operates at 10-20 GHz carrier frequencies and could benefit from an ultra-low RIN semiconductor source.

The prior art provides techniques for reducing the RIN of semiconductor lasers, but, however, over a narrow frequency range. See, for example, A. Yariv, H. Blauvelt, Shu-Wu Wu, J. Lightwave Technol. Vol. 10, 978 (1992); R. Helkey, H. Roussell, paper ThB2, Optical Fiber Communications Conference 1998; and R. J. Pedersen and F. Ebskamp, IEEE Photon. Technol. Lett. Vol. 5, 1462 (1993). Also, these techniques are complicated to implement and package into small modules.

### SUMMARY OF THE INVENTION

In one form of the invention there is provided an apparatus for the generation of ultra-low noise light comprising:

a laser generating light at a central frequency and having a frequency dependent relative intensity noise spectrum; and

an optical filter having a substantially conjugate symmetric transfer function;

wherein the center frequency of the light generated by the laser is substantially aligned with the peak transmission frequency of the filter; and

wherein the transmission function of the filter is chosen, and the frequency dependent relative intensity noise spectrum of the laser is adjusted, to reduce the resulting relative intensity noise of the light at the output of the filter over a range of frequencies by causing the relative intensity noise spectrum of the laser to occur at frequencies for which the filter has substantial loss.

### BRIEF DESCRIPTION OF THE DRAWINGS

This and other objects and features of the present invention will be more fully disclosed or rendered obvious by the following detailed description of the preferred embodiments of the invention, which is to be considered together with the accompanying drawings wherein like numbers refer to like parts and further wherein:

FIG. 1 shows the generation of spurious frequency tones by third order nonlinearity and definition of spurious free dynamic range;

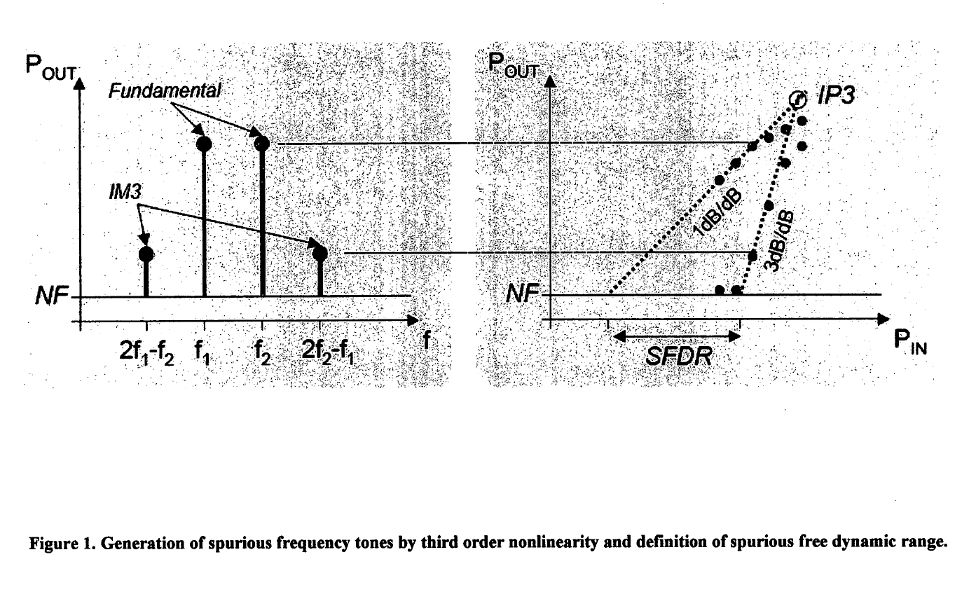

FIG. 2 illustrates the principle of operation of RIN reduction;

FIG. 3 is a graph plotting the RIN of a DFB laser as a function of frequency for a range of values of laser output power;

FIG. 4 shows the measured RIN and OSR transmission profile as a function of frequency;

FIG. 5 shows the theoretically calculated phase, amplitude, group delay and dispersion of a unipolar dispersion filter;

FIG. 6 illustrates a control loop used to keep the relative position of the laser wavelength-locked to the transmission peak of the filter; and

FIG. 7 shows the concept of a multicavity filter made of distributed Bragg reflector mirrors and cavities.

### DETAILED DESCRIPTION OF THE PREFERRED EMBODIMENTS

In a preferred embodiment of the present invention, the RIN-reduced CW laser comprises a laser (e.g., a standard high power DFB laser) followed by a passive optical filter, which may be referred to as an optical spectrum reshaper (OSR). The OSR can be made from a variety of low loss materials such as silica or transparent thin films, and can be made to be small, occupying ˜2 mm, making for a compact low RIN source. The OSR can be a variety of filters such as a Bragg grating filter, a multi-cavity waveguide ring resonator filter, a thin film filter, etc.

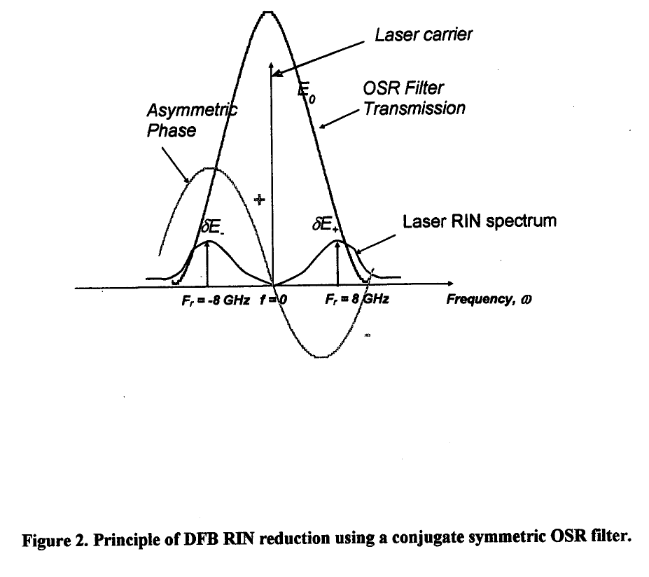

FIG. 2 shows the principle of operation of RIN reduction. The RIN of a DFB laser has a damped resonant frequency response. The laser RIN can be near the Shot noise limit at very low frequencies and increases to a peak value at the resonant frequency of the laser. The resulting optical spectrum resembles a double sideband modulated optical carrier. The RF noise in the detector is therefore generated by the sum of the beat terms between the optical carrier and the RIN sidebands on the high and low frequency sides. With the present invention, these beat frequencies are reduced by reducing the amplitudes of the RIN sidebands on the high and low frequencies without changing their relative phase in the beat terms at the receiver.

The laser noise power, as a function of RF frequency, Ω, after the OSR, is given by
ΔP_{dfb}^{OSR}(Ω)=ΔP_{DFB}H_{E}(Ω)+2P₀iΔφ_{DFB}H_{O}(Ω) (1)
Here ΔP_{DFB} is the intensity noise before the OSR, and Δφ_{DFB} is the phase noise of the laser before the OSR. The complex transfer function of the OSR, H(Ω), is broken up into the conjugate symmetric and conjugate anti-symmetric components, H_{E}, and H_{O}, both of which are functions of frequency. These are defined by

$$\begin{matrix}{H}_{e} ( Ω ) = \frac{1}{2} [ H ( Ω ) {H}^{*} ( 0 ) + H ( 0 ) {H}^{*} ( - Ω ) ] & ( 2 ) \\ {H}_{o} ( Ω ) = \frac{1}{2} [ H ( Ω ) {H}^{*} ( 0 ) - H ( 0 ) {H}^{*} ( - Ω ) ] & ( 3 )\end{matrix}$$

Note that the center frequency of the OSR is assumed to be aligned with the optical carrier frequency, which is referenced to ω0=0 for simplicity. The conjugate symmetric component (sometimes also called the even component) of the OSR transfer function, Hₑ, affects the amplitude of the RIN as represented by the first term in the equation (1), and the conjugate asymmetric (sometimes also called odd component) of the OSR, Hₒ, converts phase noise of the laser to amplitude noise after the OSR.

It is an embodiment of the present invention that the OSR be designed to be conjugate-symmetric, i.e. Hₒ=0, in order to reduce RIN.

Note that the phase imparted on the laser spectrum by a conjugate symmetric OSR is actually asymmetric, as shown in FIG. 2, so that the phase on the high frequency side has the opposite sign of that on the negative frequency side.

The spectral shape and bandwidth of the OSR is designed with the RIN spectrum of the laser in mind for maximum reduction of the RIN. Specifically, the bandwidth of the OSR is such that it substantially reduces the amplitude of the RIN noise near and above its peak resonant frequency, fᵣ. For example, if the resonant peak of the laser is at 8 GHz, as shown in FIG. 2, the 3 dB bandwidth of the OSR should be designed to be significantly lower than 8 GHz. The 3 dB bandwidth of the OSR is defined as twice the frequency at which the filter reduces the optical power through it by a factor of 2. In the example shown in FIG. 2, the 3 dB bandwidth is approximately 5 GHz. This means that the optical power through the filter is reduces by a factor of 2 at ±2.5 GHz from the peak transmission frequency of the filter.

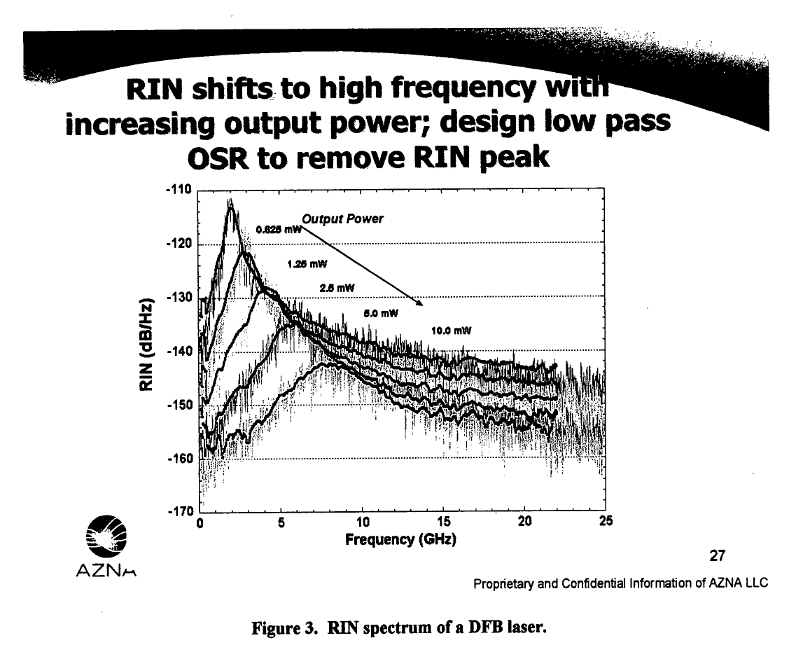

It is known in the art that the RIN of a laser, such as a DFB laser, peaks near a resonance frequency, fᵣ, which increases as the square root of the optical power in the laser cavity, i.e., fᵣ ∝\sqrt{P}ₗₐₛₑᵣ. As power is increased, the RIN peaks shift to a higher frequency. This is demonstrated in FIG. 3, where the RIN of a DFB laser is plotted as a function of frequency for a range of values of laser output power. Hence the RIN spectrum of the laser can be shifted to a higher frequency by increasing the power inside the laser cavity. Since the OSR is designed to substantially reduce RIN near and above this peak frequency, fᵣ, the combination of shifting RIN to a higher frequency and the OSR cutting out high frequencies further reduces the RIN at the output of the OSR. A simple way to increase power in a semiconductor laser cavity is to increase the CW bias current to the laser. Hence in a preferred embodiment of the present invention, the laser bias and the optical bandwidth of the OSR are selected in such a way as to push the resonant frequency fᵣ of the laser RIN spectrum to the high loss region of the OSR spectrum.

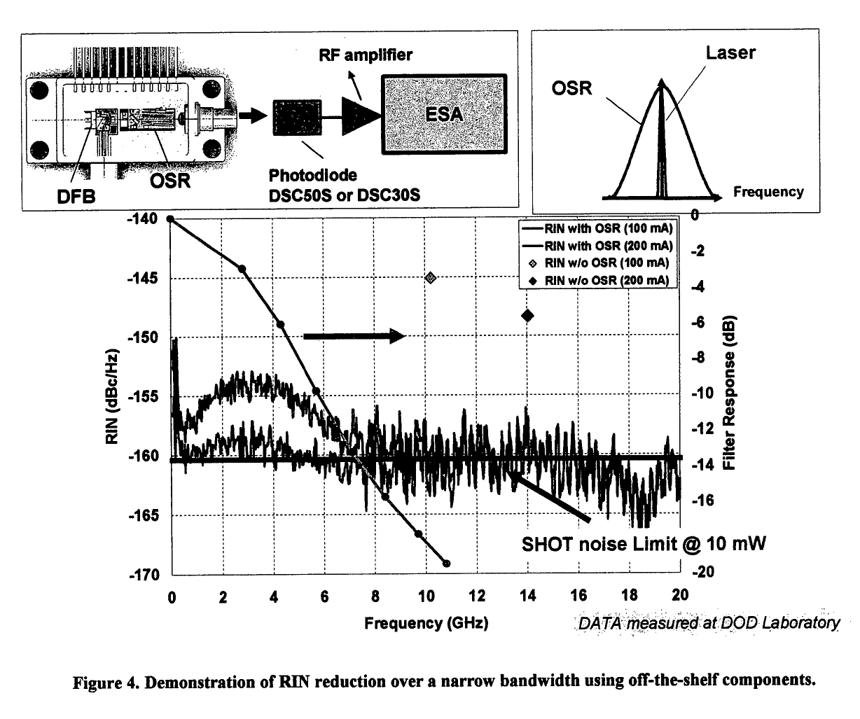

This principle has been demonstrated using a multi-cavity etalon filter and a DFB laser. FIG. 4 shows the measured RIN and OSR transmission profile as a function of frequency. These measurements were verified using a calibrated high speed RIN measurement apparatus. The RIN of the laser was measured with and without the OSR at two different bias levels of the laser, 100 mA and 200 mA. In both cases the DFB laser was temperature-tuned to align its wavelength with the peak of the transmission of the OSR. A high speed Discovery Semiconductor DSC50S or DSC30S photodetector was used to obtain a high 10-20 dBm Shot noise limit without saturating the detector. The RF amplifier and electrical spectrum analyzer (ESA) were calibrated and accuracy was verified using a laser with known RIN. As shown in FIG. 4, the RIN of the DFB laser is reduced, from a value of −145 dB/Hz without the OSR, to well below the Shot noise limit of −160 dB/Hz at frequencies above 8 GHz. The orange curve shows the transmission of the OSR as a function of frequency on the high frequency side. As the bias is increased to 200 mA, the RIN peak shifts to 14 GHz and overall RIN is further reduced. This is clearly observed at low frequencies below 8 GHz. Above 8 GHz the noise is limited by the Shot noise of the measuring apparatus. Note that the OSR was not designed for RIN reduction and so its bandwidth (˜8 GHz) was too wide for this application, but was used to demonstrate the principle. In practice, the OSR bandwidth would be designed to have a much narrower 3 dB bandwidth (on the order of <1 GHz depending on the application) so as to significantly reduce the RIN at the output of the OSR in the modulation frequency range of the analog signal to be used in the particular system. Also the OSR filter used here has an inherent asymmetry in design, which is likely to be responsible for the slight peak in RIN at low frequencies below 8 GHz. When the laser bias is increased to 200 mA, the RIN reduces further because the RIN peak shifts to a higher frequency where the current OSR has higher loss.

The maximum fiber-coupled output power of the laser demonstrated above was 20 mW, and the OSR loss was <1 dB. The low power loss of the OSR implies that a high power ultra-low RIN laser system based on the principle shown here is practical. Note that a wavelength locker is also desired as part of the laser to ensure that the laser wavelength remains aligned with the transmission peak of the OSR. However, such methods of laser wavelength locking are well known in the art.

The shape of the OSR filter is nearly Gaussian near the top of the filter in this example. Also the dispersion of the OSR filter, not shown in this example, and which is determined through the Kramers Kronig relation, is asymmetric around the peak of the filter for such a filter shape, i.e., the filter is conjugate symmetric, as desired for RIN reduction. Also the dispersion on either side of the center of the OSR filter does not change sign, and so is nearly unipolar.

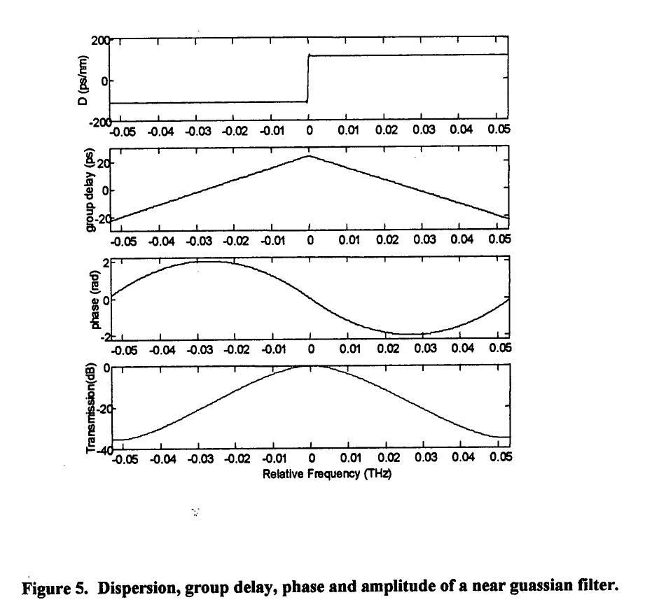

FIG. 5 shows the theoretically calculated phase, amplitude, group delay and dispersion of a unipolar dispersion filter, which has one sign of dispersion on the high frequency side of center and the opposite dispersion on the low frequency side of center. In this example, the phase imparted by the filter is positive on the low frequency side and negative on the high frequency side. This makes for the desired conjugate symmetric filter. The shape of the filter in this example is nearly Guassian. A Lorentzian shape filter, which can be arrived at with a single cavity etalon filter, also has a unipolar dispersion and phase as well. Therefore, the use of a single cavity filter after a DFB laser to reduce RIN is another embodiment of the present invention.

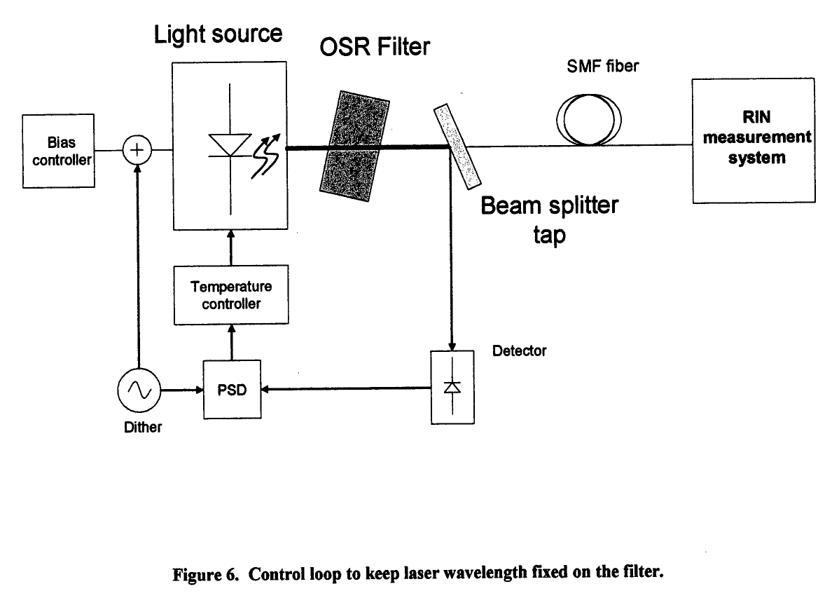

In another embodiment of the present invention, a control loop is used to keep the relative position of the laser wavelength-locked to the transmission peak of the filter, as shown in FIG. 6. A portion of the signal is tapped off after the OSR filter and the optical signal detected by a photodiode. A low frequency dither signal is used to modulate the optical frequency of the laser. The output of the photodiode is input to a phase-locked loop, and the error signal used to change the temperature of the laser and hence keep the signal locked to the middle of the filter.

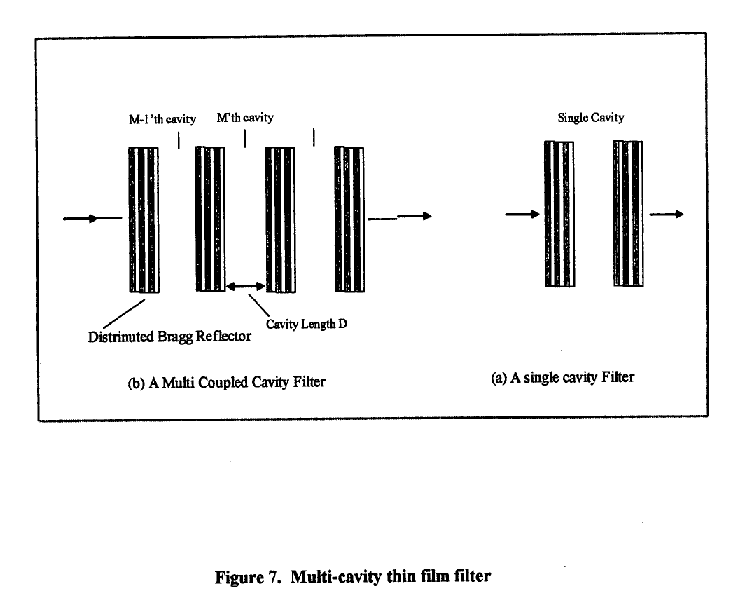

FIG. 7 shows the concept of a multicavity filter made of distributed Bragg reflector mirrors and cavities. It is possible to design such a filter by adjusting the number of layers and cavities and obtain the desired bandwidth and filter shape.

It will be appreciated that further embodiments of the present invention will be apparent to those skilled in the art in view of the present disclosure. It is to be understood that the present invention is by no means limited to the particular constructions herein disclosed and/or shown in the drawings, but also comprises any modifications or equivalents within the scope of the invention.

What is claimed is:

1. Apparatus for the generation of ultra-low noise light comprising:
a laser generating light at a central frequency and having a frequency dependent relative intensity noise spectrum; and
an optical filter having a substantially conjugate symmetric transfer function;
wherein the center frequency of the light generated by the laser is substantially aligned with the peak transmission frequency of the filter; and
wherein the transmission function of the filter is chosen, and the frequency dependent relative intensity noise spectrum of the laser is adjusted, to reduce the resulting relative intensity noise of the light at the output of the filter over a range of frequencies by causing the relative intensity noise spectrum of the laser to occur at frequencies for which the filter has substantial loss.
